(19) United States
(12) Patent Application Publication
(10) Pub. No.: US 2004/0184817 A1
(43) Pub. Date: Sep. 23, 2004

(54) Optical transmission system with optical amplifier repeaters

(75) Inventors: Jyunko Iwasaki, Tokyo (JP); Ryu Yokoyama, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/773,147

(22) Filed: Feb. 9, 2004

(30) Foreign Application Priority Data
Feb. 7, 2003 (JP) 030182/2003

(51) Int. Cl. H04B 10/02

(52) U.S. Cl. 398/177

(57) ABSTRACT

An optical transmission system with optical amplifier repeaters whereby a flattened gain spectrum can be obtained even when a small number of pumping light sources is used in a Raman amplifier repeater. In the optical transmission system with optical amplifier repeaters, first optical amplifier repeaters at plural stages and a second optical amplifier repeater having a gain control function are located in a gain control zone. The respective first optical amplifier repeaters perform backward pumping to corresponding Raman amplification optical fibers by outputting pumping lights having different wavelengths by backward pumping. Accordingly, a variety of wavelengths are used in the gain control zone as a whole. Consequently, it becomes possible to obtain a flattened gain spectrum. Further, the second optical amplifier repeater performs a control of compensating distortion of spectral characteristics when a failure occurs in at least one of the first optical amplifier repeaters.

### BACKGROUND OF THE INVENTION

The present invention generally relates to optical transmission systems with optical amplifier repealers, and in particular, to an optical transmission system with optical amplifier repeaters employing Raman amplifiers to transmit multiple-wavelength signal lights.

### DESCRIPTION OF THE RELATED ART

The increasing demands for various kinds of communication systems including the Internet promote the use of WDM (Wavelength-Division-Multiplexing) optical transmission system in which capacity of transmission is drastically increased. Heretofore, an erbium-doped optical fiber has been used to multiplex signal lights. However, when optical fiber amplification is performed with the erbium-doped optical fiber, a range of available wavelengths is limited. Accordingly, it is impossible to perform speedy communication with wider bandwidth. In this connection, an optical transmission system with optical amplifier repeaters employing Raman amplification has gathered attention. By adopting the Raman amplification, it becomes possible to amplify such a wide wavelength band of 100 nm at a time and to amplify signal lights in S band (1460-1630 nm). Further, it becomes possible to obtain a wideband and flat gain by the use of a multiple-wavelength excitation light source.

FIG. 1 is a diagram showing a configuration of a conventional optical transmission system with optical amplifier repeaters. The optical transmission system 100 comprises a first to n-th Raman amplifier repeaters 101₁ to 101ₙ to compensate losses in a transmission line. These repeaters 101₁ to 101ₙ are located in sequence at intervals along a transmission direction 102. Raman amplification optical fibers 103₁ to 103ₙ, which correspond to the first to n-th Raman amplifier repeaters 101₁ to 101ₙ, respectively, are located on the input side of the corresponding Raman amplifier repeater. In this system with this configuration, the respective repeaters 101₁ to 101ₙ supply pumping lights for Raman amplification by a backward pumping method to perform amplification of signal lights.

Since the respective first to n-th Raman amplifier repeaters 101₁ to 101ₙ have the same configuration, only the first Raman amplifier repeater 101₁ is depicted in detail in FIG. 1. The Raman amplifier repeater 101₁ comprises a pumping laser control section 111, laser diodes (LDs) 112₁ to 112₄, a first optical coupler 115, a second optical coupler 116, and a third optical coupler 117. The pumping laser control section 111 controls pumping laser. Further, the section 111 controls respective pumped states of the first to fourth LDs 112₁ to 112₄. The first optical coupler 115 synthesizes Raman amplification pumping lights 113₁ and 113₂, which have first and second wavelengths and are output from the first and second LDs 112₁ and 112₂, respectively, to output a first Raman amplification pumping light 114₁. The second optical coupler 116 synthesizes Raman amplification pumping lights 113₃ and 113₄, which have third and fourth wavelengths and are output from the third and fourth LDs 112₃ and 112₄, respectively, to output a second Raman amplification pumping light 114₂. The third optical coupler 117 supplies the first and second Raman amplification pumping lights 114₁ and 114₂ output from the first and second optical couplers 115 and 116, respectively, to the Raman amplification optical fiber 103₁ using the backward pumping method.

In the transmission line of the optical amplifier repeater system in FIG. 1, signal lights are transmitted through the first to n-th Raman amplifier repeaters 101₁ to 101ₙ in this order. During the transmission, signal losses are caused in the optical fibers 103₁ to 103ₙ. The signal losses are compensated by amplification of signal lights performed in the fibers 103₁ to 103ₙ. Each of the Raman amplifier repeaters 101₁ to 101ₙ has the plural LDs 112₁ to 112₄ (in this example, four LDs) which output Raman Amplifcation pumping lights 113₁ to 113₄ whose wavelength are different from each other to flat a gain spectrum by Raman amplification by itself.

FIGS. 2A to 2C are diagrams for explaining processes of flattening a gain spectrum with the use of plural Raman pumping wavelengths. In this example, two Raman pumping wavelengths are employed, FIG. 2A shows a first pumping light 121₁ having a first wavelength λ₁ and a first gain spectrum 122₁ generated by supplying the pumping light 121₁ to the Raman amplification optical fiber 103 (refer to FIG. 1). FIG. 2B shows a second pumping light 121₂ having a second wavelength λ₂, which is different from the first wavelength λ₁, and a second gain spectrum 122₂ generated by supplying the pumping light 121₂ to the Raman amplification optical fiber 103. FIG. 2C shows a gain spectrum 122₃ obtained when the first and second pumping lights 121₁ and 121₂ are fed into the Raman amplification optical fiber 103 at the same time for excitation. The gain spectrum 122₃ is the combination of the first and second gain spectra 122₁ and 122₂ each having a peak at a different wavelength. Accordingly, when pumping lights having appropriate gain spectra are synthesized, the resultant gain becomes flatter than the gain spectrum by a single pumping light. While in FIGS. 2A to 2C two kinds of pumping lights 121₁ and 121₂ are employed, it is also possible to synthesize many more Raman amplification pumping lights, for example, four kinds of Raman amplification pumping lights 113₁ to 113₄ shown in FIG. 1 to obtain much flatter gain spectrum.

As described above, by the use of many Raman amplification pumping lights, it becomes possible not only to realize a high-power pumping light generally required for Raman amplification but also to avoid deep distortion of a gain spectrum and deep decrease of a pumping light power even when a failure occurs in a part of the pumping power sources. Accordingly, the reliability of the optical transmission system with optical amplifier repeaters can be secured. Such a technique is proposed in, for example, Japanese Patent Application Laid-Open Nos. 2002-40495 and 2002-40496.

In an undersea transmission system, there is a need to perform multiple-wavelength transmission of large-volume data over great distances. To satisfy the need, there is focused on an optical transmission system with optical amplifier repeaters employing Raman amplifiers. However, since the Raman amplification requires a comparatively high-power pumping light, some fields of optical amplifier repeater transmission systems including the undersea transmission system limit the number of pumping light sources available in each Raman amplifier repeater in view of restriction on power-consumption Accordingly, there is a big challenge of how to realize the flattening of a gain spectrum on the premise of the restricted number of pumping light sources. Especially in long-distance transmission, many more Raman amplifier repeaters have to be used in the transmission line. In this case, the nonuniformity of a gain spectrum is gradually amplified by each Raman amplifier repeater, which may lead to errors in receiving a signal light having a wavelength with a small gain at the end of the transmission line, etc. Moreover, under the situation where a relatively small number of pumping light sources is provided in respective Ram an amplifier repeaters in view of power consumption, when a failure of output occurs in a part of the pumping light sources, not only the form of a gain spectrum becomes uneven but also a receiving level of a signal light dips from a reference level in some wavelength ranges. In this case, errors may occur when receiving signal lights as with the above case.

### SUMMARY OF THE INVENTION

It is therefore an object of the present invention to provide an optical transmission system with optical amplifier repeaters capable of flattening a gain spectrum even when a relatively small number of pumping light sources is employed in respective Raman amplifier repeaters.

It is another object of the present invention to provide an optical transmission system with optical amplifier repeaters capable of avoiding errors on receipt of signal lights even when a failure occurs in at least one of the pumping light sources in a Raman amplifier repeaters.

According to the present invention, there is provided an optical transmission system with optical amplifier repeaters whereby a flattened gain spectrum can be obtained even when a small number of pumping light sources is used in a Raman amplifier repeater. According to the present invention, for achieving the objects mentioned above, there is provided an optical transmission system with optical amplifier repeaters, wherein a plurality of repeaters each of which outputs a pumping light with a different pumping wavelength spectrum to realize a different gain spectrum are located in a predetermined gain control zone in an optical fiber transmission line for Raman amplification.

Namely, a gain control zone is provided in the optical fiber transmission line for transmitting signal lights. Further, the respective repeaters in the gain control zone output pumping lights with different pumping wavelength spectra to obtain different gain spectra. Raman amplification is performed by using the different wavelengths from the repeaters in the gain control zone. Since the number of wavelengths used for the Raman amplification becomes severalfold compared with a case where Raman amplification is performed using a single wavelength from one repeater, it becomes possible to obtain a flatter gain spectrum.

More specifically, in the optical transmission system with optical amplifier repeaters, first optical amplifier repeaters at plural stages and a second optical amplifier repeater having a gain control function are located in a gain control zone. The respective first optical amplifier repeaters perform backward pumping to corresponding Raman amplification optical fibers by outputting pumping lights having different wavelengths by pumping. Accordingly, a variety of wavelengths are used in the gain control zone as a whole. Consequently, it becomes possible to obtain a flattened gain spectrum. Further, the second optical amplifier repeater performs a control of compensating distortion of spectral characteristics when a failure occurs in at least one of the first optical amplifier repeaters.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a configuration of a conventionally proposed optical transmission system with optical amplifier repeaters;

FIGS. 2A to 2C are diagrams for explaining the flattening of a gain spectrum using a plurality of Raman pumping wavelengths;

FIG. 3 is a diagram showing a configuration of a substantial part of an optical transmission system with optical amplifier repeaters according to a first embodiment of the present invention;

FIG. 4 is a block diagram briefly showing configuration of a first optical amplifier repeater used in the first embodiment;

FIG. 5 is a diagram showing a condition of transmission of monitor information in the first embodiment;

FIG. 6 is a block diagram briefly showing a configuration of a second optical amplifier repeater used in the first embodiment;

FIG. 7 is a diagram showing a relationship between respective pumping light sources and wavelengths in the first Raman optical amplifier repeaters used in the first embodiment;

FIG. 8 is a diagram for explaining a principle of control to flatten a gain spectrum by the second optical amplifier repeater used in the first embodiment;

FIG. 9 is a diagram for explaining another example of a gain spectrum;

FIG. 10 is a diagram showing a concrete example of total gain characteristics by the first optical amplifier repeater used in the first embodiment;

FIG. 11 is a diagram showing a state of a gain spectrum when a failure occurs in the first optical amplifier repeater at the first stage in the first embodiment;

FIG. 12 is a diagram showing a state of a gain spectrum when a failure occurs in the first optical amplifier repeater at the second stage in the first embodiment;

FIG. 13 is a diagram showing a state of a gain spectrum when a failure occurs in the first optical amplifier repeater at the third stage in the first embodiment;

FIG. 14 is a diagram showing a state of a gain spectrum when a failure occurs in the first optical amplifier repeater at the fourth stage in the first embodiment;

FIG. 15 is a diagram showing a relationship between respective pumping light sources and wavelengths in first optical amplifier repeaters used in a first modified embodiment of the first embodiment;

FIG. 16 is a block diagram showing a configuration of a substantial part of a second optical amplifier repeater used in a second modified embodiment of the first embodiment;

FIG. 17 is a diagram showing a configuration of a substantial part of an optical transmission system with optical amplifier repeaters according to a third modified embodiment of the first embodiment;

FIG. 18 is a block diagram showing a configuration of a first optical amplifier repeater at the fourth stage used in the third modified embodiment;

FIG. 19 is a diagram showing a configuration of a substantial part of an optical transmission system with optical amplifier repeaters according to a fourth modified embodiment of the first embodiment;

FIG. 20 is a diagram showing a configuration of a substantial part of an optical transmission system with optical amplifier repeaters according to a fifth modified embodiment of the first embodiment;

FIG. 21 is a block diagram showing a configuration of a second optical amplifier repeater at the (m+1)-th stage used in the fifth modified embodiment;

FIG. 22 is a diagram showing a configuration of a substantial part of an optical transmission system with optical amplifier repeaters according to a second embodiment of the present invention; and

FIG. 23 is a block diagram showing a gain control device used in the second embodiment.

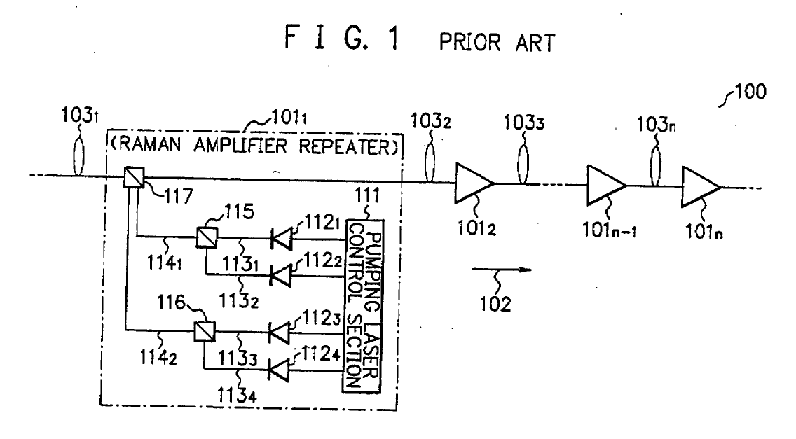

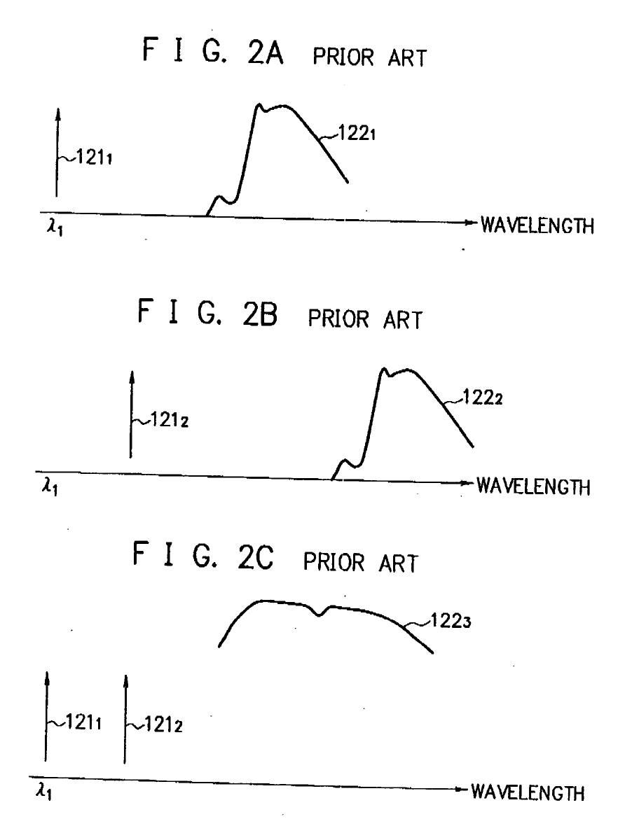

### DESCRIPTION OF THE PREFERRED EMBODIMENTS

Referring now to the drawings, embodiments of the present invention are explained in detail

### First Embodiment

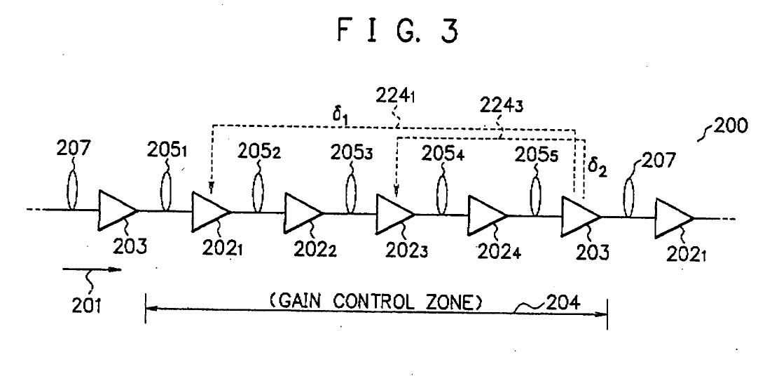

FIG. 3 is a diagram showing a substantial part of an optical transmission system with optical amplifier repeaters according to the first embodiment of the present invention. While the optical transmission system 200 allows two-way communication of multiplexed signal lights, FIG. 3 only shows communication in an outward direction 201 in which signal lights are transmitted as depicted by an arrow. The optical transmission system 200 comprises first optical amplifier repeaters 202₁ to 202₄ at the first to fourth stages, respectively, a second optical amplifier repeater 203, and Raman amplification optical fibers 205₁ to 205₅. The first optical amplifier repeaters 202₁ to 202₄ perform Raman amplification to compensate losses in a transmission line. The second optical amplifier repeater 203 has a gain control function and is located behind the first optical amplifier repeaters 202₁ to 202₄ (on the side of the end of the transmission line). The first optical amplifier repeaters 202₁ to 202₄ and the second optical amplifier repeater 203 are located in series in this order in a gain control zone 204 along the outward direction 201. The gain control zone 204 is sequentially repeated over the whole transmission line (not shown in FIG. 3). The Raman amplification optical fibers 205₁ to 205₆ corresponds to the first optical amplifier repeaters 202₁ to 202₄ at the first to fourth stages and the second optical amplifier repeater 203, respectively (the fiber 205₅ corresponds to the repeater 203), and located ahead of the corresponding repeaters 202₁ to 202₄ and 203 (on the side of the beginning of the transmission line).

Incidentally, there is no need to allocate plural gain control zones 204 in the whole transmission line from beginning to end. The gain control zone(s) 204 may be located in a certain section of the transmission line. Obviously, at least one gain control zone 204 may be located in the transmission line.

In the optical transmission system 200 according to the first embodiment, the second optical amplifier repeater 203 in the gain control zone 204 checks out the degree of flatness of a gain spectrum by Raman amplification. When an event of deteriorating the degree of flatness of a gain spectrum occurs in or before the gain control zone 204, the second optical amplifier repeater 203 transmits control signals to the first optical amplifier repeaters 202₁ to 202₄ at the first to fourth stages to control their outputs of pumping lights to the corresponding Raman amplification optical fibers 205₁ to 205₅ by backward pumping. By this means, it becomes possible to obtain a flat gain spectrum.

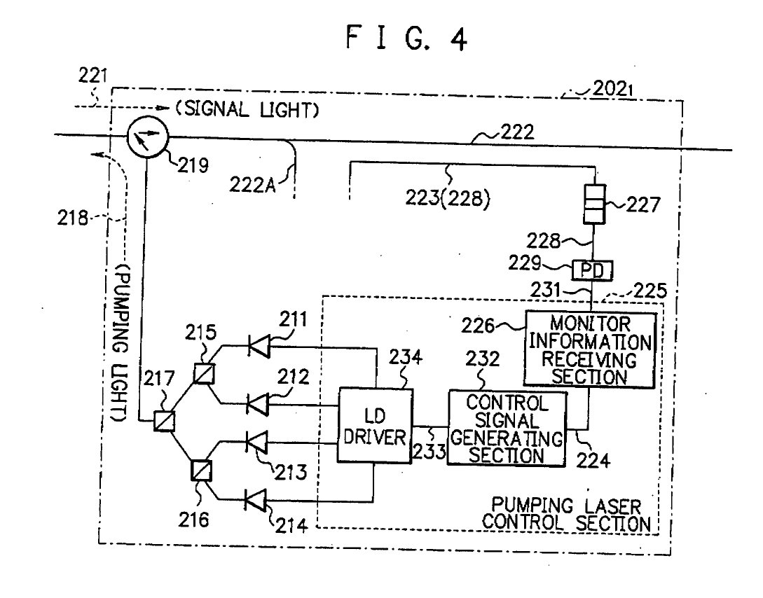

FIG. 4 is a diagram showing a circuitry of the first amplifier repeater at the side of the outward transmission line used in the first embodiment. The homeward transmission side is provided with the same circuitry as this, thereby abbreviating the explanations. The first optical amplifier repeater 202₁ at the first stage comprises first to fourth pumping light sources 211 to 214 for outputting Raman amplification pumping lights having different wavelengths λ₁₁ to λ₁₄, respectively. The first to fourth pumping light sources 211 to 214 are composed of laser diodes (LDs) for outputting Raman amplification pumping lights, respectively. While in FIG. 4 only the configuration of the first optical amplifier repeater 202₁ at the first stage at the outward side is depicted in detail, the other first optical amplifier repeaters 202₂ to 202₄ at the second to fourth stages basically have the same configuration as this, thereby abbreviating the diagrammatic representation and explanation. In this regard, however, the first to fourth pumping light sources 211 to 214 in the first optical amplifier repeater 202₂ at the second stage output Raman amplification pumping lights having wavelengths λ₂₁ to λ₂₄, respectively. In the same manner, the first to fourth pumping light sources 211 to 214 in the first optical amplifier repeater 2023 at the third stage output Raman amplification pumping lights having wavelengths λ₃₁ to λ₃₄, respectively. The first to fourth pumping light sources 211 to 214 in the first optical amplifier repeater 202₄ at the fourth stage output Raman amplification pumping lights having wavelengths λ₄₁ to λ₄₄, respectively.

A first coupler 215 is located at the output side of the first and second pumping light sources 211 and 212 to synthesize the pumping lights having the wavelengths λ₁₁ and λ₁₂ output therefrom, respectively. In the similar way, a second coupler 216 is located at the output side of the third and fourth pumping light sources 213 and 214 to synthesize the pumping lights having the wavelengths λ₁₃ and λ₁₄ output therefrom, respectively. Further, a WDM (Wavelength-Division Multiplex) coupler 217 is located at the output side of the first and second couplers 215 and 216 to supply a pumping light 218, which is obtained by synthesizing the Raman amplification pumping light wavelengths λ₁₁ to λ₁₄ different from each other, to the Raman amplification optical fiber 205₁ shown in FIG. 3 by a backward pumping method via an optical circulator 219.

On the other hand, a signal light transmitted from the Raman amplification optical fiber 205₁ to the first optical amplifier repeater 202₁ at the first stage proceeds to an optical fiber transmission line 222 which leads to the next Raman amplification optical fiber 205₂ (refer to FIG. 3) via the optical circulator 219.

The first optical amplifier repeater 202₁ at the first stage is provided with a pumping laser control section 225 for controlling an output of a pumping light 218 used for the backward pumping. The pumping laser control section 225 includes a monitor information receiving section 226, a control signal generating section 232 and a LD driver 234. A signal light 223 which proceeds at the homeward transmission side in the direction opposite to the outward direction 201 is branched and input into a filter 227. Subsequently, the filter 227 extracts wavelength components of a monitor information 228, and outputs it. Thereafter, a photo diode (PD) 229 is subjected to the light of the monitor information 228 and feeds a received light output 231 into the monitor information receiving section 226. By this means, the monitor information receiving section 226 reproduces monitor information 224 transmitted from the second optical amplifier repeater 203.

The control signal generating section 232 retrieves control information about the first to fourth pumping light sources 211 to 214 in the first optical amplifier repeater 202₁ at the first stage from the regenerated monitor information 224. Subsequently, the section 232 generates control signals 233 which control the first to fourth pumping light sources 211 to 214, respectively, and supplies the control signals 233 to the LD driver 234. The LD driver 234 controls the driving of the first to fourth pumping light sources 211 to 214 according to the control signals 233. The explanation of the detailed control processes will be given later.

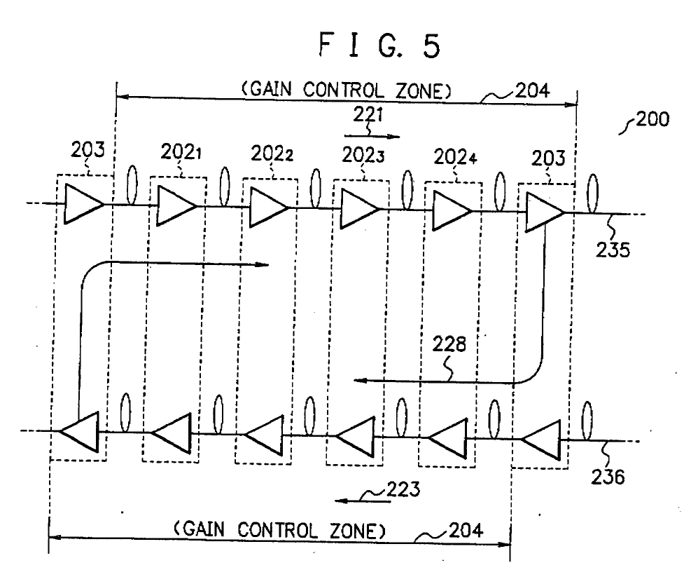

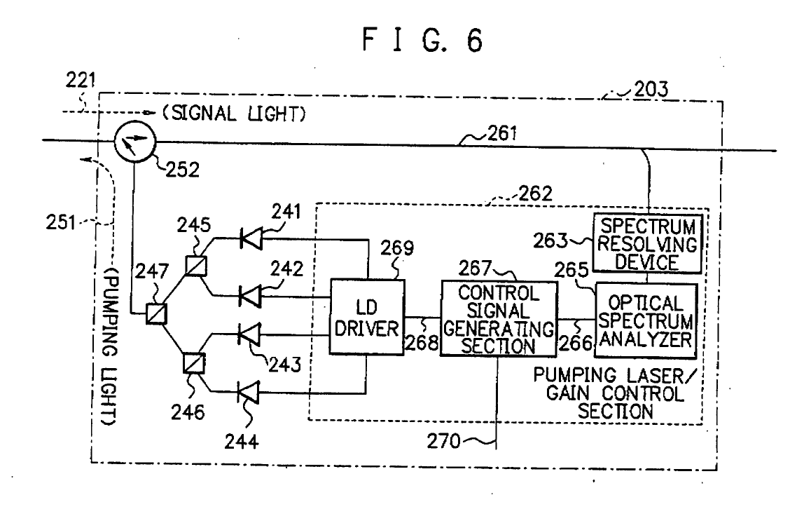

FIG. 5 is a diagram for explaining a condition of transmission of the monitor information used in the optical transmission system with optical amplifier repeaters according to the first embodiment. In the optical transmission system 200 according to the first embodiment, signal lights (main signals) for outward transmission is transmitted via an optical fiber 235 as an outward transmission line, and signal lights (main signals) for homeward transmission is transmitted via an optical fiber 236 as a homeward transmission line. As shown in FIG. 4, the optical circulator 219 blocks lights that go in the reverse direction in the optical transmission line 222. Consequently, the second optical transmitter repeater 203 transmits the monitor information 228 for compensating gain spectra of signal lights (main signals) for outward transmission via the optical fiber 236 for homeward transmission. The second optical amplifier repeater 203 will be explained in detail later with FIG. 6.

The monitor information 228 is transmitted via the optical fiber 236 for homeward transmission as a signal light 223 along with main signals, and input into the filter 227 as the signal light 223 shown in FIG. 4. Subsequently, the wavelength components of the monitor information 228 are extracted. The optical fiber transmission line 222 shown in FIG. 4 is provided with a branch line 222A for retrieving monitor information for homeward transmission from the signal light 221 transmitted in the outward transmission line. The branch line 222A retrieves the monitor information for homeward direction (not shown) and delivers the information to a monitor information receiving section at the side of the homeward transmission line via a filter (not shown).

FIG. 6 shows a brief configuration of the second optical amplifier repeater 203 shown in FIG. 3 at the side of the outward transmission line. Another second optical amplifier repeater 203 is provided at the side of the homeward transmission line with the same circuitry as this, thereby abbreviating the explanation. The second optical amplifier repeater 203 is provided with fifth to eighth pumping light sources 241 to 244 for outputting Raman amplification pumping lights. The fifth to eighth pumping light sources 241 to 244 are composed of laser diodes (LDs) that output Raman amplification pumping lights having different wavelengths λ₅ to λ₈, respectively. In addition, the fifth to eighth pumping light sources 241 to 244 serves as backup pumping light sources at the time of failure in the first optical amplifier repeater 202₁ to 202₄.

A first coupler 245 is located at the output side of the fifth and sixth pumping light sources 241 and 242 to synthesizes the pumping lights having wavelengths λ₅ and λ₆. In the same manner, a second coupler 246 is located at the output side of the seventh and eighth pumping light sources 243 and 244 to synthesize the pumping lights having wavelengths λ₇ and λ₈. Further, a WDM coupler 247 is located at the output side of the first and second couplers 245 and 246, and output a pumping light 251. The pumping light 251 is supplied via an optical circulator 252 into the Raman amplification optical fiber 205₅ shown in FIG. 3 by the backward pumping method. Incidentally, the monitor information for homeward transmission is superposed on the pumping light 251 transmitted to the optical circulator 252.

The signal light 221 in the outward transmission line transmitted from the Raman amplification optical fiber 205₅ shown in FIG. 3 to the second optical amplifier repeater 203 proceeds to an optical fiber transmission line 261 that leads to the next Raman amplification optical fiber 207 (refer to FIG. 3) via the optical circulator 252.

The second optical amplifier repeater 203 is provided with a pumping laser/gain control section 262 for controlling pumping laser and a gain spectrum. The pumping laser/gain control section 262 includes a spectrum resolving device 263, an optical spectrum analyzer 265, a control signal generating section 267 and a LD driver 269. A signal line 270 leads to a control signal generating section (267; not shown) in a second optical amplifier repeater (203; not shown) at the side of the homeward transmission line. The spectrum resolving device 263 inputs therein a signal light branched from a signal light 221 transmitting in the outward transmission line. The spectrum resolving device 263 resolves the spectrum of the input signal light and feeds the resolved signal lights into the optical spectrum analyzer 265. The analyzer 265 analyzes the optical spectrum, and feeds the analysis results 266 into the control signal generating section 267. The control signal generating section 267 generates control signals for controlling wavelength components for fifth to eighth pumping light sources (241 to 244; not shown) located in the second optical amplifier repeater (203) at the side of the homeward transmission line, and control signals for wavelength components for the first optical amplifier repeaters 202₁ to 202₄ at the first to fourth stages at the side of the outward transmission line. The control signal generating section 267 supplies the control signals for the fifth to eighth pumping light sources (241 to 244) to the control signal generating section (267) in the second optical amplifier repeater (203) at the side of the homeward transmission line via the signal line 270. The control signal generating section (267) at the side of the homeward transmission lines generates control signals (268; not shown) for controlling the respective fifth to eighth pumping light sources (241 to 244) at the slide of the homeward transmission line on the basis of the supplied control signals, and supplies the generated control signals to a LD driver (269; not shown) at the side of the homeward transmission line. The LD driver (269) drives the fifth to eighth pumping light sources (241 to 244) at the side of the homeward transmission line.

The control signals for controlling the respective wavelength components for the first optical amplifier repeaters 202₁ to 202₄ at the first to fourth stages are transmitted to a circuit section (not shown) at the side of homeward transmission via the signal line 270 that connects the outward and homeward transmission lines. The transmitted control signals are output to an optical fiber homeward transmission line (not shown) as wavelength components of the monitor information 228. On the other hand, monitor information for homeward transmission is transmitted via the signal line 270. The monitor information for homeward transmission is used for feeding back analysis results of spectrum to the first optical amplifier repeaters (202₁ to 202₄) at the side of the homeward transmission line. The monitor information for homeward transmission is converted into optical signals at a circuit section (not shown in FIG. 6). The converted optical signals are transmitted toward the next gain control zone 204 (the further right-side zone next to the second optical amplifier repeater 203 depicted at the extreme right in FIG. 5) as a part of the signal light 221 via the optical fiber transmission line 261 along with main signals.

Incidentally, the control signals for the fifth to eighth pumping light sources 241 to 244 in FIG. 6 at the side of the outward transmission line are also transmitted from the side of the homeward transmission line via the signal line 270.

In the optical transmission system with optical amplifier repeaters according to this embodiment, the second optical amplifier repeater 203 in FIG. 3 monitors a degree of gain flatness and a deviance from a normal value in the gain control zone 204. Further, the optical spectrum analyzer 265 resolves spectra of signals transmitted in the optical fiber transmission line 261 to detect a difference value, which indicates a wavelength range with a decreased signal output.

Subsequently, the second optical amplifier repeater 203 identifies a pumping light source capable of compensating the gain variation and an amplifier repeater including the pumping light source in the gain control zone 204 according to the detected difference value and respective central wavelengths. FIG. 3 shows an example where the second optical amplifier repeater 203 outputs monitor information 224₁ to the first optical amplifier repeater 202₁ at the first stage to control the output from the first pumping light source 211 therein by controlled variable δ₁, and outputs the monitor information 224₃ to the first optical amplifier repeater 202₃ at the third stage to control the output from the fourth pumping light source 214 therein by controlled variable δ₂. By this means, the second optical amplifier repeater 203 located at the end of the gain control zone 204 performs gain control so as to output a signal light having a flat spectrum. In the following, an explanation will be given of a detailed method of gain equalization.

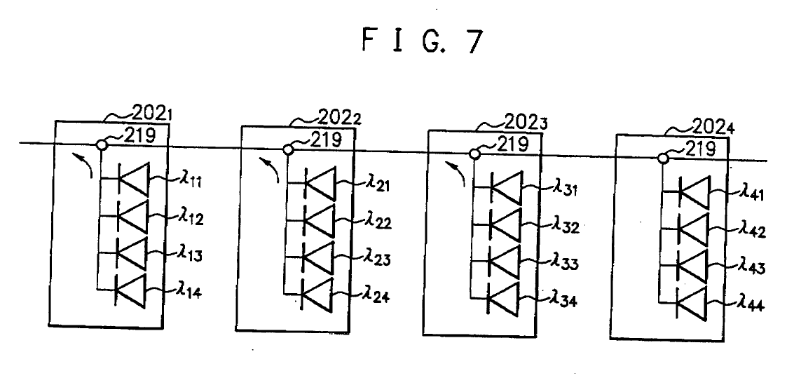

FIG. 7 shows a relationship between respective pumping light sources and wavelengths in the first optical amplifier repeaters 202₁ to 202₄ in this embodiment. As shown in FIG. 7, the first optical amplifier repeaters 202₁ to 202₄ at the first to fourth stages are provided with the first to fourth pumping light sources 211 to 214 as shown in FIG. 4. The repeaters 202₁ to 202₄ output Raman amplification pumping lights with different four wavelengths λ₁₁ to λ₁₄, λ₂₁ to λ₂₄, λ₃₁ to λ₃₄, and λ₄₁ to λ₄₄, respectively, by the backward pumping method. The repeaters 202₁ to 202₄ at the first to fourth stages supply the Raman amplification pumping lights to the corresponding Raman amplification optical fibers 205₁ to 205₄ (not shown in FIG. 7), respectively, via their own optical circulators 219. However, since the optical circulator 219 blocks lights proceeding in the optical fiber transmission line 222 shown in FIG. 4 in the reverse direction, the Raman amplification pumping light used for backward pumping works on only the corresponding Raman amplification optical fiber 205 for amplification operation. Accordingly, the Raman amplification pumping lights are set to have different wavelengths λ₁₁ to λ₁₄, λ₂₁ to λ₂₄, λ₃₁ to λ₃₄, and λ₄₁ to λ₄₄, respectively, to compensate a distortion (depression) of a gain profile of the optical amplifier repeater located before.

The second optical amplifier repeater 203 shown in FIG. 6 is located as a repeater at the last stage of the gain control zone 204 shown in FIG. 3, and monitors the signal lights received at the spectrum resolving device 263 therein. Subsequently, the optical spectrum analyzer 265 detects a deviation from a normal value.

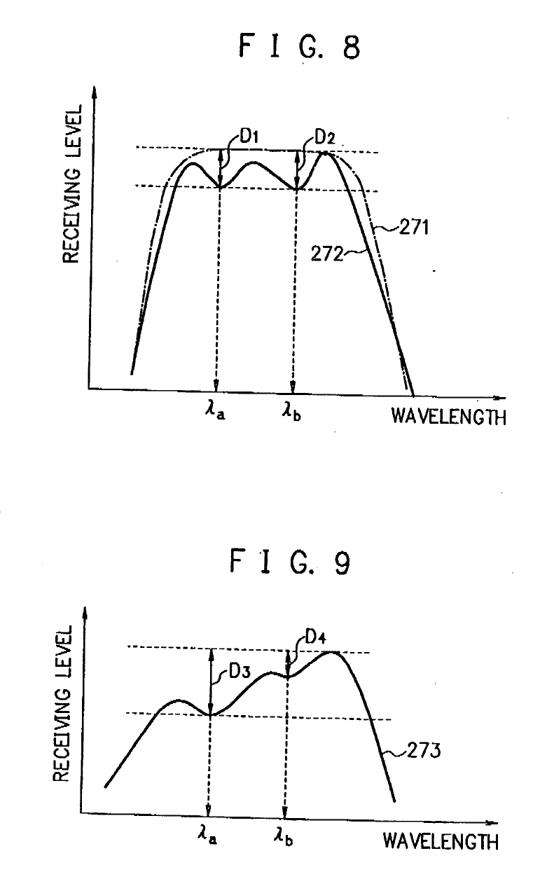

FIG. 8 is a diagram for explaining a principle of control to flatten a gain spectrum by the second amplifier repeater 203. The gain spectrum is flattened by applying a plurality of pumping light sources to a required part of a signal spectrum. In FIG. 8, the vertical axis shows a receiving level of a signal light, and the horizontal axis shows a wavelength of the signal light. The dashed curved line 271 shows an ideal or a normal gain spectrum. The full curved line 272 shows a case where distortions are partially generated in the gain owing to failure in a part of the pumping light sources. Hereat, respective degradation amounts (attenuance) D₁ and D₂ indicate the maximum degradation amount in the positions where the respective receiving levels are dropped under a normal value. Further, the spectrum 272 is degraded (deteriorated) at the wavelengths λₐ and λ_{b}.

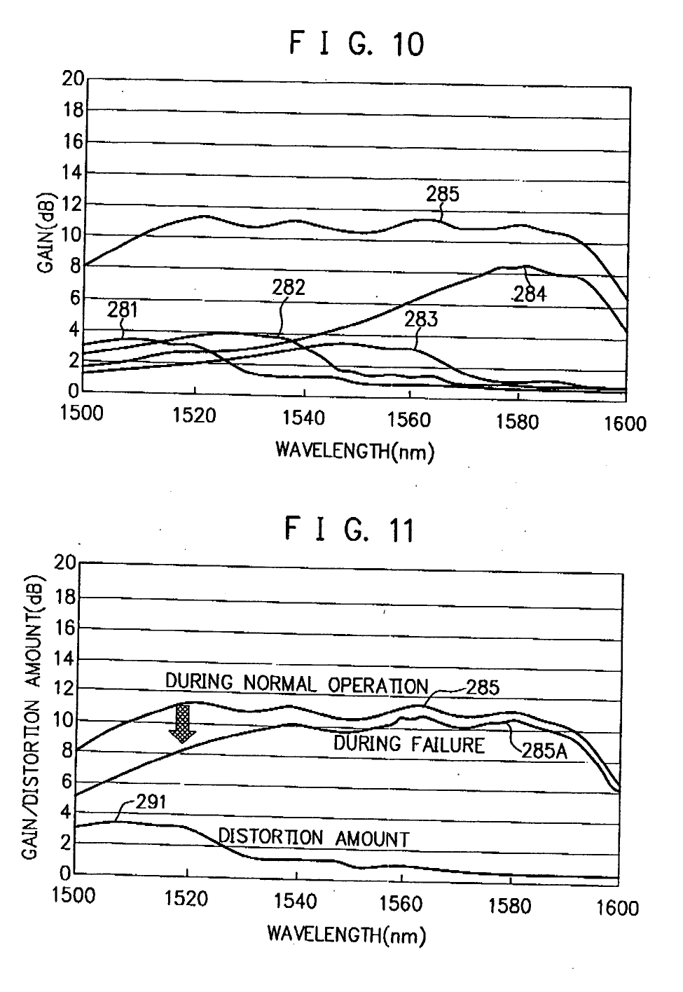

FIG. 9 shows an example of another gain spectrum. The curved line 273 shows a gain spectrum in this case, in which the degradation amounts D₃ and D₄ are different from each other in comparison with the case of FIG. 8.

The spectrum resolving device 263 shown in FIG. 6 resolves the signal lights by respective wavelengths to obtain the respective receiving levels, and identifies the positions (wavelengths) where the receiving levels are dropped and the degradation amounts D₁ and D₂ (degradation amounts D₃ and D₄ in the case of FIG. 9). The optical spectrum analyzer 265 identifies pumping wavelengths required in the positions of wavelengths having gain reduction to increase to the normal value. Subsequently, the optical spectrum analyzer 265 compares the identified pumping wavelength with the respective wavelengths λ₁₁ to λ₁₄, λ₂₁ to λ₂₄, λ₃₁ to λ₃₄, and λ₄₁ to λ₄₄, as pumping wavelengths of the first optical amplifier repeaters 202₁ to 202₄ at the first to fourth stages and with the respective wavelengths λ₅ to λ₈ as pumping wavelengths of the second optical amplifier repeater 203. Thereafter, the analyzer 265 identifies a wavelength most approximate to the identified pumping wavelength and repeaters having a pumping light source for the wavelength. Subsequently, the analyzer 265 operates the control of increasing the pumping light output of the identified pumping light sources.

Incidentally, the optical spectrum analyzer 265 may identify a pumping light source and a repeater each and every time. However, the analyzer 265 may identify a pumping light source and a repeater by referring to a table prepared in advance in which relationships between a wavelength and a repeater and between the repeater and a pumping light source are associated with each other with respect to each wavelength.

FIG. 10 is a diagram showing a concrete example of a total gain characteristic by the first optical amplifier repeater used in the first embodiment. Hereat, a total gain spectrum as a first gain spectrum 281 is obtained by the backward pumping with pumping lights from the first to fourth pumping lights 211 to 214 in the first optical amplifier repeater 202₁ at the first stage. The first gain spectrum 281 is obtained by using the four kinds of Raman amplification pumping lights having different wavelengths λ₁₁ to λ₁₄, respectively. In the same manner, a total gain spectrum as a second gain spectrum 282 is obtained by the backward pumping with pumping lights from the first to fourth pumping lights 211 to 214 in the first optical amplifier repeater 202₂ at the second stage. The second gain spectrum 282 is obtained by using the four kinds of Raman amplification pumping lights having different Wavelengths λ₂₁ to λ₂₄, respectively. Moreover, a total gain spectrum as a third gain spectrum 283 is obtained by the backward pumping with the pumping lights from the first to fourth pumping lights 211 to 214 in the first optical amplifier repeater 202₃ at the third stage. The third gain spectrum 283 is obtained by using the four kinds of Raman amplification pumping lights having different wavelengths λ₃₁ to λ₃₄, respectively. Furthermore, a total gain spectrum as a fourth gain spectrum 284 is obtained by the backward pumping with pumping lights from the first to fourth pumping lights 211 to 214 in the first optical amplifier repeater 202₄ at the fourth stage. The fourth gain spectrum 284 is obtained by using the four kinds of Raman amplification pumping lights having different wavelengths λ₄₁ to λ₄₄, respectively. A synthetic profile obtained by synthesizing the first to fourth gain spectra 281 to 284 is equivalent to a synthetic profile obtained by synthesizing the total 16 kinds of wavelengths of Raman amplification pumping lights, consequently obtaining a flattened total gain spectrum 285.

On the other hand, FIG. 11 shows a state of a total gain spectrum when a failure occurs in the first optical amplifier repeater 202, at the first stage and a pumping light is not output completely. In this case, the total gain spectrum 285A is obtained, in which the first gain spectrum 281 shown in FIG. 10 is not synthesized. Further, the absence of the first gain spectrum 281 adversely acts as a distortion amount 291 against the total gain spectrum 285 in the normal state.

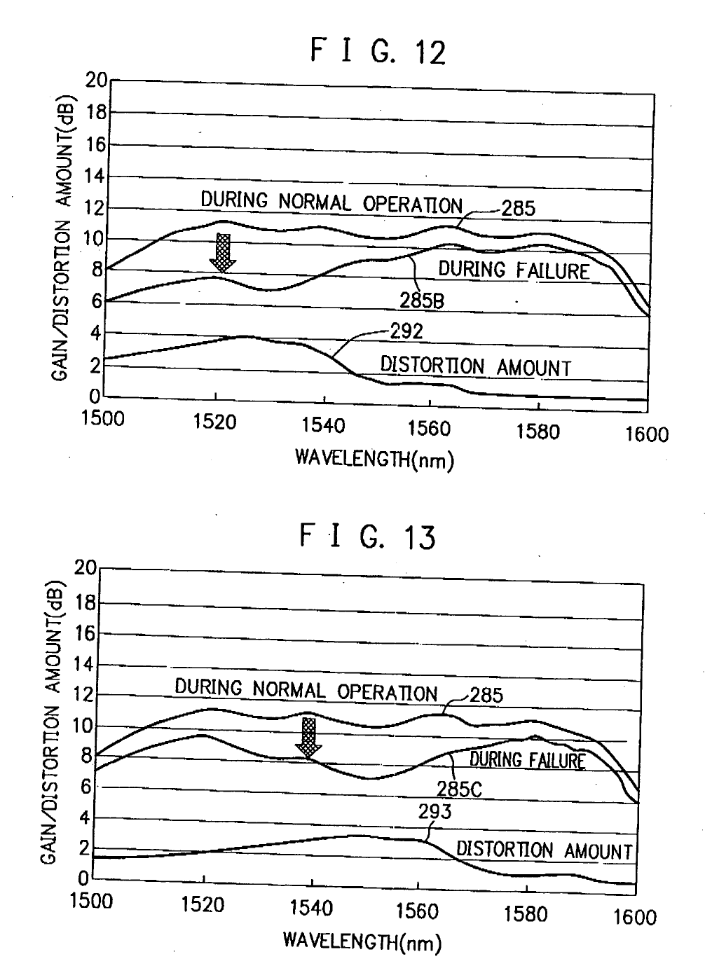

FIG. 12 shows a state of a total gain spectrum when a failure occurs in the first optical amplifier repeater 202₂ at the second stage and a pumping light is not output completely. In this case, the total gain spectrum 285B is obtained, in which the second gain spectrum 282 shown in FIG. 10 is not synthesized. Further, the absence of the second gain spectrum 282 adversely acts as a distortion amount 292 against the total gain spectrum 285 in the normal state.

FIG. 13 shows a state of a total gain spectrum when a failure occurs in the first optical amplifier repeater 202₃ at the third stage and a pumping light is not output completely. In this case, the total gain spectrum 285C is obtained, in which the third gain spectrum 283 shown in FIG. 10 is not synthesized Further, the absence of the third gain spectrum 283 adversely acts as a distortion amount 293 against the total gain spectrum 285 in the normal state.

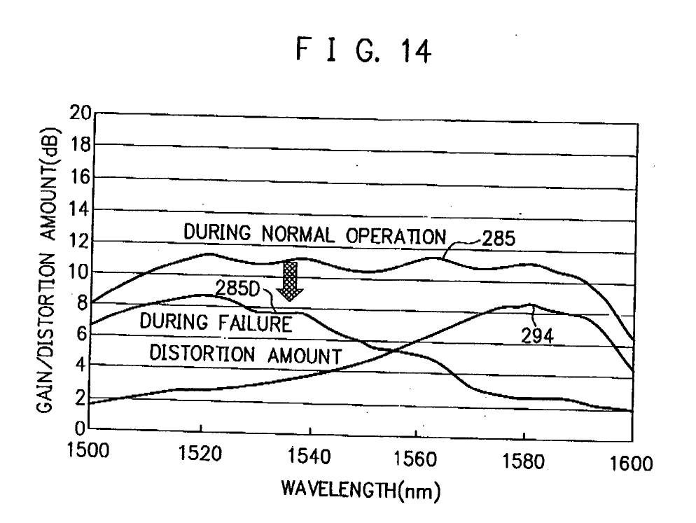

FIG. 14 shows a state of a total gain spectrum when a failure occurs in the first optical amplifier repeater 202₄ at the fourth stage and a pumping light is not output completely. In this case, the total gain spectrum 285D is obtained, in which the fourth gain spectrum 284 shown in FIG. 10 is not synthesized. Further, the absence of the fourth gain spectrum 284 adversely acts as a distortion amount 294 against the total gain spectrum 285 in the normal state.

Hereinbefore, FIGS. 11 to 14 show the cases where the first to fourth pumping light sources 211 to 214 in the respective first optical amplifier repeaters does not output pumping lights completely. Aside from these cases, there may occur some other failures such that an output level(s) of a part or all of the first to fourth pumping light sources 211 to 214 is decreased and such that some of the pumping light sources fail in outputting the pumping lights while the other pumping light sources normally output the pumping lights. In these cases, the second optical amplifier repeater 203 outputs monitor information 224 as instructions to a corresponding first optical amplifier repeater to increase the pumping light level. By this means, the output from the corresponding pumping light source is increased, and consequently, it becomes possible to restore the deteriorated spectrum to the total gain spectrum 285 in the normal state.

Further, in the case where an output level(s) of at least one of the first to fourth pumping light sources 211 to 214 in the respective first optical amplifier repeaters 202₁ to 202₄ at the first to fourth stages is higher than a normal level owing to some reasons, the second optical amplifier repeater 203 transmits monitor information 224 to decrease an output from a corresponding pumping light source. By this means, it becomes possible to restore the distorted spectrum to the total gain spectrum 285 in the normal state.

On the other hand, sometimes it is impossible for the second optical amplifier repeater 203 to obtain the total gain spectrum 285 in the normal state although the second optical amplifier repeater 203 transmits the monitor information 224 to a repeater that causes the failure from among the first optical amplifier repeaters 202₁ to 202₄, This problem may occur when the output of the pumping light is incompletely improved, or the first to fourth pumping light sources 211 to 214 of a corresponding repeater remains completely halting the outputs therefrom. When failing in restoring to the total gain spectrum 285 in the normal state as above cases, the second optical amplifier repeater 203 controls the respective fifth to eighth pumping light sources 241 to 244 therein shown in FIG. 6 to output their pumping lights at a predetermined rate, respectively. By this control, the repeater 203 outputs a pumping light 251 for realizing a gain spectrum proximate to the present distortion amount. The pumping light 251 is supplied to the Raman amplification optical fiber 205₅ shown in FIG. 3 by the backward pumping method. By this means, it becomes possible to obtain the total gain spectrum 285 in the normal state or a spectrum proximate to the spectrum 285. The control using the fifth to eighth pumping plight sources 241 to 244 are performed on the basis of the feedback control by the optical spectrum analyzer 265, the control signal generating section 267, and the LD driver 269, whereby it becomes possible to always keep a certain degree of flatness of a gain spectrum.

### First Modified Embodiment of First Embodiment

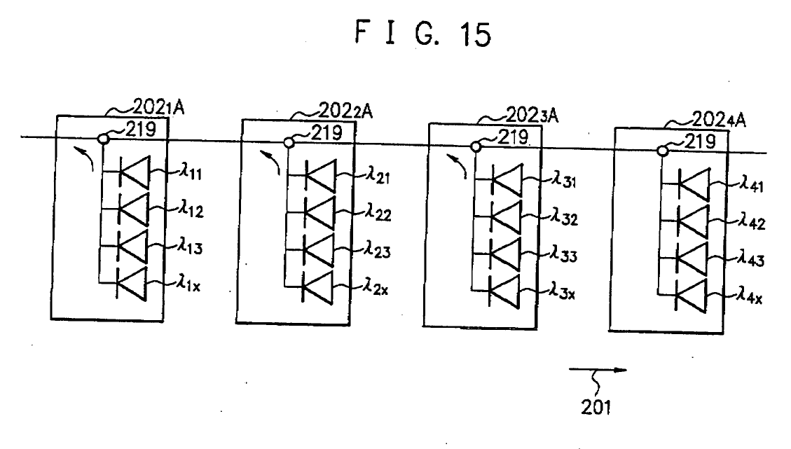

FIG. 15 corresponds to FIG. 7, and shows a relationship between respective pumping light sources and wavelengths in first optical amplifier repeaters used in a first modified embodiment of the first embodiment. In this modified embodiment, each gain control zone 204 comprises a second optical amplifier repeater 203 and first optical amplifier repeaters 202₁A to 202₄A at the fit to fourth stages as shown in FIG. 15. However in this modified embodiment, only the first to third pumping light sources 211 to 213 in the respective first optical amplifier repeaters 202₁A to 202₄A at the first to fourth stages always output Raman amplification pumping lights having different wavelengths λ₁₁ to λ₁₃, λ₂₁ to λ₂₃, λ₃₁ to λ₃₃, and λ₄₁ to λ₄₃. The fourth pumping light sources 214 in the respective repeaters 202₁A to 202₄A are backup light sources. When a failure occurs in one of the first to third pumping light sources 211 to 213 in the repeaters 202₁A to 202₄A, the fourth pumping light sources 214 in the repeaters 202₁A to 202₄A output pumping lights having wavelengths λ₁ₓ to λ₄ₓ, respectively, which are the same wavelengths as that of the pumping light of the failure pumping light source. The instructions to output the pumping light from the fourth pumping light source 214 is based on the monitor information 224 shown in FIG. 4, and transmitted to a corresponding repeater.

Obviously, the first optical amplifier repeaters 202₁A to 202₄A at the first to fourth stages may comprises five pumping light sources, respectively. In this case, the first to fourth pumping light sources 211 to 214 outputs the four kinds of Raman amplification pumping lights having different wavelengths λ₁₁ to λ₁₄, λ₂₁ to λ₂₄, λ₃₁ to λ₃₄, and λ₄₁ to λ₄₄, respectively, for the backward pumping method. At the time of failure, the fifth pumping light source as a backup light source outputs the same pumping light as that of any one of the first to fourth pumping light sources 211 to 214 having the failure.

### Second Modified Embodiment of First Embodiment

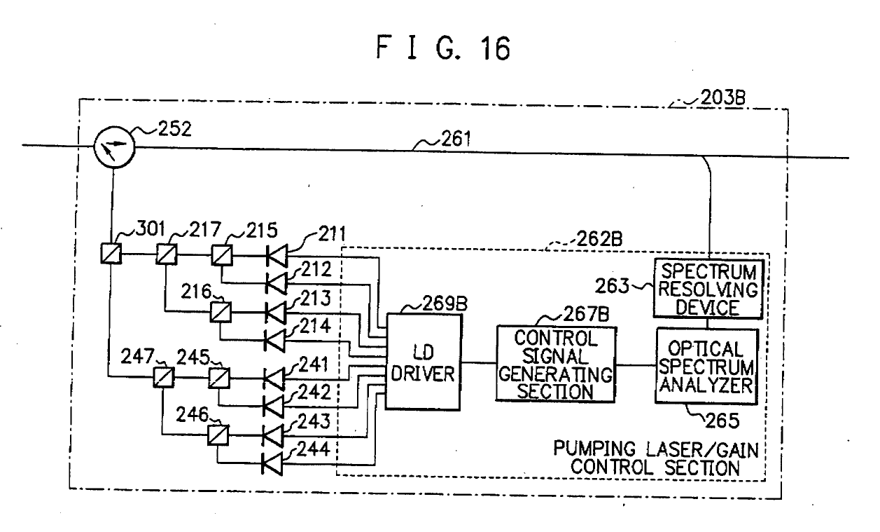

FIG. 16 is a block diagram showing a configuration of a substantial part of a second amplifier repeater according to a second modified embodiment of the first embodiment In FIG. 16, the same reference numbers as those in FIGS. 4 and 6 represent the same parts, thereby abbreviating the explanations. The second optical amplifier repeater 203B used in the second modified embodiment comprises the first to fourth pumping light sources 211 to 214 as with the first optical amplifier repeater 202 used in the first embodiment. The repeater 203B synthesizes pumping lights from the pumping light sources 211 to 214 and supplies the synthesized pumping light to the Raman amplification optical fiber 205₅ shown in FIG. 3 via the WDM coupler 217, an optical coupler 301, and the optical circulator 252 by the backward pumping method. Namely, while in the former embodiments the second optical amplifier repeater 203 does not supply an own original pumping light, the second optical amplifier repeater 203B in this second modified embodiment supplies the own pumping light to the Raman amplification optical fiber 205₅. Therefore, it becomes possible to reduce one first optical amplifier repeater 202 according to need.

Further, the second optical amplifier repeater 203B comprises the fifth to eighth pumping light sources 241 to 244 as backup light sources as with the former embodiments. The second optical amplifier repeater 203B outputs a pumping light, which is obtained via the optical coupler 301 synthesizing the pumping lights from the WDM couplers 217 and 247, to the optical circulator 252. When a failure occurs in any one of the first optical amplifier repeaters 202₁ to 202₄ at the first to fourth stages, a control signal generating section 267B generates control signals to alternatively drive the fifth to eighth pumping light sources 241 to 244 on the basis of the analysis by an optical spectrum analyzer 265. In this case, the control signals are supplies to a LD driver 269B without being processed into the monitor information 224 to control the driving of the fifth to eighth pumping light sources 241 to 244.

The LD driver 269 obviously controls the driving of the first to fourth pumping light sources 211 to 214 in the second optical amplifier repeater 203B. Moreover, when a failure occurs in the first to fourth pumping light sources 211 to 214 in the second optical amplifier repeater 203B or those drive members, the drive members for driving the fifth to eighth backup pumping light sources 241 to 244 in the LD driver 269B substantially performs the operation for the first to fourth pumping light sources 211 to 214.

In the optical transmission system with optical amplifier repeaters according to the second modified embodiment, there is no need to transmit the monitor information 224 to the first optical amplifier repeaters 202₁ to 202₄ at the first to fourth stages different from the former embodiments. Accordingly, it becomes possible to simplify the circuitry of the repeaters shown in FIG. 4. Further, this second modified embodiment may be applied to an optical transmission system performing one-way communication.

### Third Modified Embodiment of First Embodiment

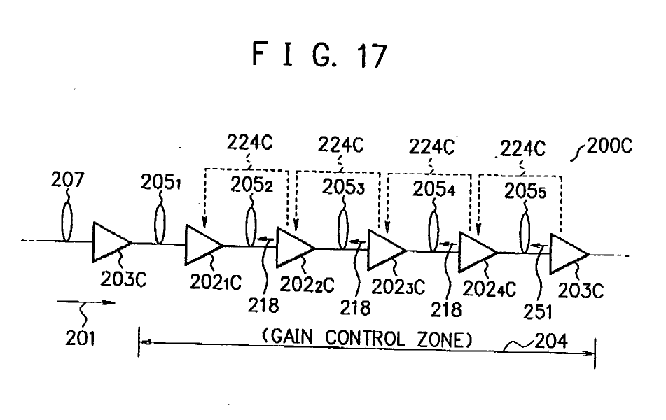

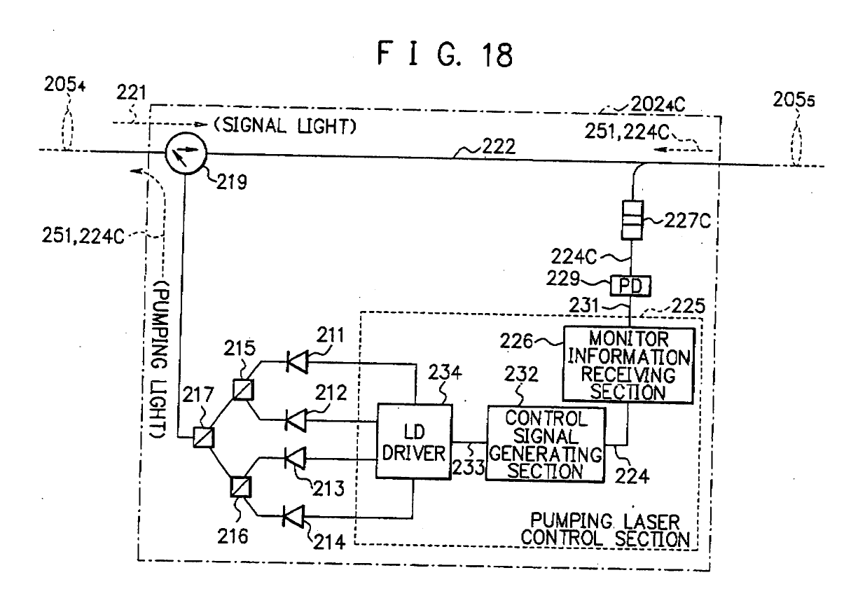

FIG. 17 shows a configuration of a substantial part of an optical transmission system with optical amplifier repeaters according to a third modified embodiment of the first embodiment. In the third modified embodiment, the transmission method of the monitor information is changed. As described hereinbefore, the optical circulator 219 in the first optical amplifier repeater 202₁ to 202₄ at the first to fourth stages shown in FIG. 4 blocks the lights proceeding in the optical transmission line 222 in the reverse direction. In this connection, in the optical transmission system 200C shown in FIG. 17, a second optical amplifier repeater 203C supplies monitor information 224C to the Raman amplification optical fiber 205₅ together with the pumping light 251 supplied by the backward pumping method to transmit the monitor information 224C inside a first optical amplifier repeater 202₄C at the fourth stage. The first optical amplifier repeater 202₄C at the fourth stage separates the monitor information 224C. Subsequently, the first optical amplifier repeater 202₄C supplies the separated monitor information 224C to the Raman amplification optical fiber 205₄ together with the pumping light 218 by the backward pumping method to transmit the separated monitor information 224C to the first optical amplifier repeater 202₃C at the third stage. In the same manner, the monitor information 224C is transmitted to the first optical amplifier repeater 202₁C at the first stage.

FIG. 18 shows a configuration of the first optical amplifier repeater 202₄C at the fourth stage used in the third modified embodiment. The first optical amplifier repeaters 202₁C to 202₃C at the first to third stages have the same configuration as that of repeater 202₄C, thereby abbreviating the diagrammatic representation and explanation. Incidentally, the first optical amplifier repeater 202₁C at the first stage does not have to transmit the monitor information 224C received from the first optical amplifier repeater 202₂C at the second stage to the anterior side of the transmission line.

In FIG. 18, the same reference numerals as those in FIG. 4 denote the same parts, thereby abbreviating the explanations. In the first optical amplifier repeater 202₄C at the fourth stage, the signal light 221 proceeds in the optical fiber transmission line 222 toward the Raman amplification optical fiber 205₅ via the optical circulator 219. On the other hand, the pumping light 251 and the monitor information 224C are transmitted from the Raman amplification optical fiber 205₅ in the direction opposite to the transmitting direction of the signal light 221. The pumping light 251 and the monitor information 224C reaches the optical circulator 219, however, those transmissions are blocked hereat.

However in the fist optical amplifier repeater 202₄C at the fourth stage used in the third modified embodiment, the pumping light 251 and the monitor information 224C are branched and input into a filter 227C. The filter 227C blocks the pumping light 251 and passes only the monitor information 224C. Accordingly, the PD 229 receives the monitor information 224C and inputs the received light output 231 to the monitor information receiving section 226. By this means, the monitor information receiving section 226 can reproduce the monitor information 224 transmitted from the second optical amplifier 203 Accordingly, there is no need to transmit the monitor information about the signal lights for outward transmission in the homeward transmission line. Consequently, the optical fiber transmission line 222 does not have to be provided with the branch line 222A shown in FIG. 4.

The pumping laser control section 225 and the other circuitry in FIG. 18 are the same as those in FIG. 4. In the third modified embodiment, the LD driver 234 controls the driving of the first to fourth pumping light sources 211 to 214 on the basis of the reproduced monitor information 224C. At the same time, the LD driver 234 transmits the monitor information 224C as information about predetermined wavelength components via the first to fourth pumping light sources 211 to 214 to the optical circulator 219 together with the pumping light 251. The optical circulator 219 outputs the pumping light 251 and the monitor information 224C to the Raman amplification optical fiber 205₄. By this means, the monitor information 224C is sequentially transmitted in the reverse direction as shown in FIG. 17.

### Fourth Modified Embodiment of First Embodiment

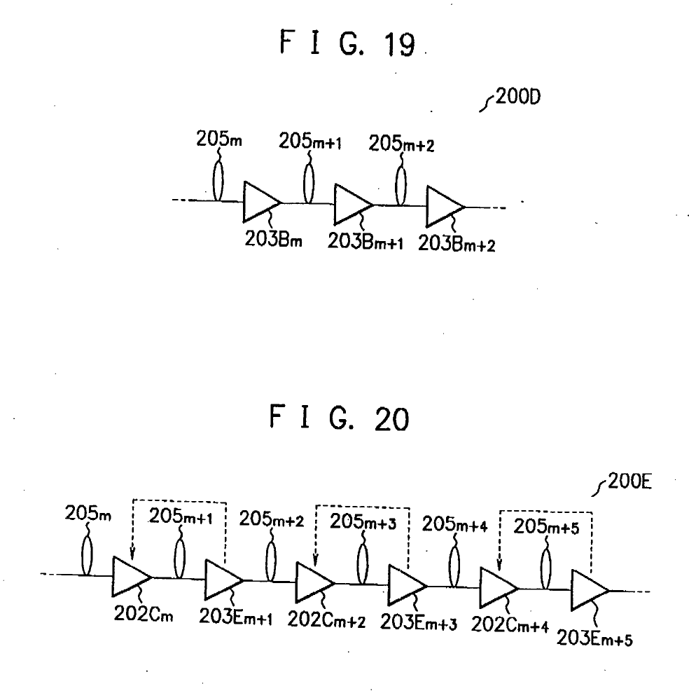

FIG. 19 shows a configuration of a substantial part of an optical transmission system with optical amplifier repeaters according to a fourth modified embodiment of the first embodiment. In the optical transmission system 200D, all of the repeaters have the same configuration as the second optical amplifier repeater 203B shown in FIG. 16. Consequently, each of the optical spectrum analyzers 265 in the second optical amplifier repeaters 203Bₘ, 203Bₘ₊₁, 203Bₘ₊₂, . . . , checks the degree of flatness of a gain spectrum. When gain distortion exists due to a failure in a pumping light source(s) in an anterior repeater, the respective second optical amplifier repeaters 203Bₘ, 203Bₘ₊₁, 203Bₘ₊₂, . . . , of the fourth modified embodiment use at least one of the own fifth to eighth pumping light sources 241 to 244 to supply a pumping light to a corresponding Raman amplification optical fiber from among the fibers 205ₘ, 205ₘ₊₁, 205ₘ₊₂, . . . , by the backward pumping to compensate the gain distortion. Incidentally, the first to fourth pumping light sources 211 to 214 in the respective second optical amplifier repeaters 203Bₘ, 203Bₘ₊₁, 203Bₘ₊₂, . . . , are prepared for backup light sources for backward pumping on the premise of compensating the transmission losses in the normal state.

While in the optical transmission system 200D shown in FIG. 19 all of the repeaters have the same configuration as the second optical amplifier repeater 203B, this amplifier repeater 203B may be located between repeaters having other configuration(s) at intervals. By this means, even when the degree of flatness of a gain spectrum is decreased due to a failure in anther repeater, it becomes possible to compensate the gain distortion using the fifth to eighth pumping light sources 241 to 244. Accordingly, it becomes possible to secure the flatness of a gain spectrum. Also in this case, there is no need to transmit monitor information to the other repeaters since the respective second optical amplifier repeaters 203B is allowed to amplify the gain via the adjacent Raman amplification optical fibers 205 to secure the flatness of the gain.

### Fifth Modified Embodiment of First Embodiment

FIG. 20 shows a configuration of a substantial part of an optical transmission system with optical amplifier repeaters according to a fifth modified embodiment of the first embodiment. In the optical transmission system 200E, first optical amplifier repeaters 202Cₘ, 202Cₘ₊₂, 202Cₘ₊₄, . . . , each having the same configuration as the first optical amplifier repeater 202₄C shown in FIG. 18 and second optical amplifier repeaters 203Eₘ₊₁, 203Eₘ₊₃, 203Bₘ₊₅, . . . , are alternately disposed as repeaters. A Raman amplification optical fiber 205ₘ is located just before the first optical amplifier repeater 202Cₘ, and in the same manner, the Raman amplification optical fibers 205ₘ₊₁, 205ₘ₊₂, are disposed between respective repeaters.

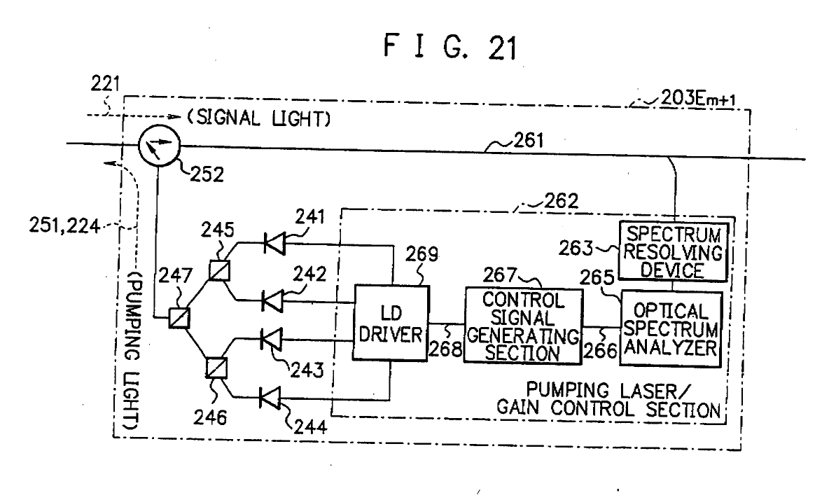

FIG. 21 shows a configuration of a second optical amplifier repeater at (m+1)-th stage used in the fifth modified embodiment. The other second optical amplifier repeaters 203Eₘ₊₃, 203Eₘ₊₅, . . . , have the same configuration as the repeater 203Eₘ₊₁. In FIG. 21, the same reference numerals as those in FIG. 6 represent the same parts, thereby abbreviating the explanations. In the second optical amplifier repeater 203Eₘ₊₁, the output from the WDM coupler 247 (this may be replaced by the other coupler), which synthesizes the wavelength components of the pumping lights from the fifth to eighth pumping light sources 241 to 244, is directly transmitted to the optical circulator 252. Accordingly, not only the pumping light 251 but also the monitor information 224 that indicates instructions to perform compensation on the basis of the analysis by the optical spectrum analyzer 265 is supplied via the optical circulator 252 to the Raman amplification optical fiber 205ₘ₊₁ (refer to FIG. 20) just before the second optical amplifier repeater 203Eₘ₊₁. The pumping light 251 is used in the Raman amplification optical fiber 205ₘ₊₁ for backward pumping. The monitor information 224 passes the Raman amplification optical fiber 205ₘ₊₁ and is input into the first optical amplifier repeater 202Cₘ at the anterior stage backward.

As obvious from FIG. 18, in the first optical amplifier repeater 202Cₘ, the monitor information 224 is transmitted via the Raman amplification optical fiber 205ₘ₊₁ in the reverse direction (the Raman amplification optical fiber 205ₘ₊₁ corresponds to the Raman amplification optical fiber 205₅ in FIG. 18). Subsequently, the PD 229 receives the monitor information 224, and the control of the first to fourth pumping light sources 211 to 214 is performed. By this means, a gain spectrum is flattened. Incidentally, the optical circulator 219 in the first optical amplifier repeater 202Cₘ tries to transmit the monitor information 224 to the former stages of the optical transmission line 222 at the side of the outward transmission line. However, an optical circulator 252 in a second optical amplifier 203Eₘ₋₁ (not shown, and refer to FIG. 21) blocks the proceeding of the monitor information 224. This will not entail any adverse consequence.

### Second Embodiment

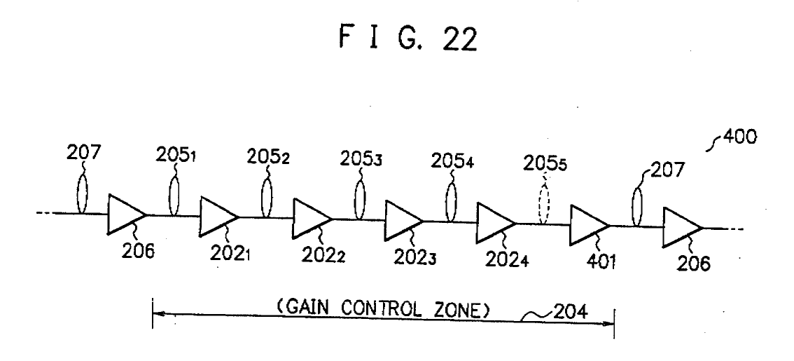

FIG. 22 shows a configuration of a substantial part of an optical transmission system with optical amplifier repeaters according to a second embodiment of the present invention. In FIG. 22, the same reference numbers as those in FIG. 3 represent the same parts, thereby abbreviating the explanations. The optical transmission system 400 according to the second embodiment comprises first optical amplifier repeaters 202₁ to 202₄ at the first to fourth stages and a gain control device 401. The first optical amplifier repeaters 202₁ to 202₄ at the first to fourth stages performs Raman amplification to compensate losses in a transmission line. The gain control device 401 is located after the repeaters 202₁ to 202₄ (on the side of the end of the transmission line), and performs only gain control. The repeaters 202₁ to 202₄ and the gain control device 401 are located in this order in series in a predetermined gain control zone 204. Raman amplification optical fibers 205₁ to 205₄ are located just before the corresponding repeaters 202₁ to 202₄, respectively, in the gain control zone 204 (on the side of the beginning of the transmission line). Incidentally, the gain control device 401 does not output a pumping light different from the first embodiment. Accordingly, the Raman amplification optical fiber 205₅ as an optical fiber having Raman amplification characteristics is not necessarily required in the second embodiment.

As described above, the optical transmission system 400 comprises the first optical amplifier repeaters 202₁ to 202₄ at the first to fourth stages for gain equalization and the gain control device 401 for issuing instructions to the repeaters 202₁ to 202₄. The device 401 is not provided with function to perform gain equalization by itself, Incidentally, while in FIG. 22 there is depicted a single gain control zone 204, a plurality of signal gain control zones 204 may be disposed over the transmission line. Moreover, a normal optical amplifier repeater 206 for performing amplification by a fixed amplification factor (gain) may be included in the gain control zone 204. FIG. 22 shows an example in which the normal optical amplifier repeaters 206 are disposed outside the gain control zone 204.

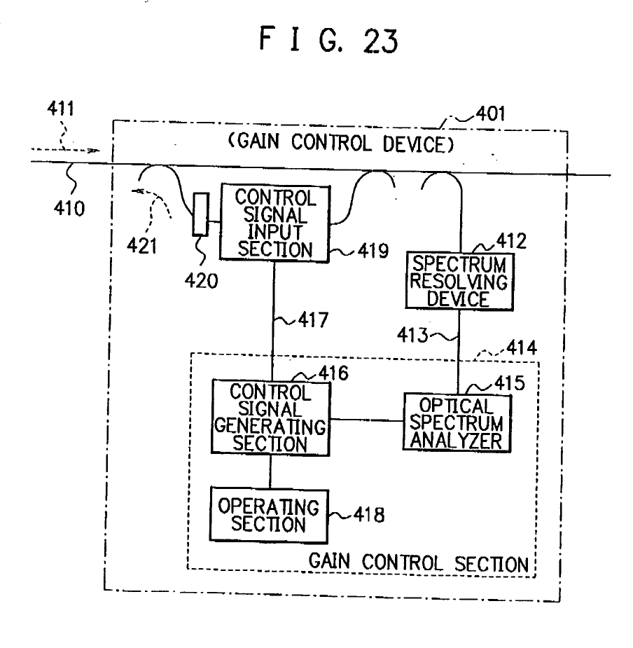

FIG. 23 shows the gain control device 401 used in the second embodiment in detail. The gain control device 401 comprise a spectrum resolving device 412, a gain control section 414, a control signal input section 419, and a filter 420. The gain control section 414 includes an optical spectrum analyzer 415, a control signal generating section 416, and an operating section 418. The spectrum resolving device 412 inputs therein a signal light 411 transmitted in an optical fiber transmission line 410 to perform spectral resolution. The spectrum analyzer 415 inputs therein the analysis result 413 from the spectrum resolving device 412 to analyze the optical spectrum. The control signal generating section 416 generates control signals 417 for controlling the corresponding first optical amplifier repeaters 202₁ to 204₄ at the first to fourth stages according to the analysis result 413. At the time of generation of the control signals 417, the operating section 418 performs operation necessary for gain compensation.

The gain control device 401 is not provided with pumping light sources for backward pumping different from the second amplifier repeater 203 used in the first embodiment. Accordingly, the control signals 417 are input into the control signal input section 419 to be processed into light signals. The light signals are reversely transmitted in the optical fiber transmission line 410. The control signal input section 419 is composed of a modulator, and the like (not shown). The control signals are output to the optical fiber transmission line 410 as monitor information 421 having a certain wavelength allowed to pass the filter 420. The filter 420 prevents the signal lights 411 transmitted in the optical fiber transmission line 410 from being input into the control signal input section 419.

While in the above-described respective embodiments and modified embodiments the Raman amplification is performed by the backward pumping method, it is also possible to perform the amplification by using a forward pumping method or both pumping methods.

Moreover, while in the above-described respective embodiments and modified embodiments the pumping light sources in the respective optical amplifier repeaters output pumping lights having different wavelengths, it is also possible to use at least one pair of pumping light sources with respect to each wavelength for outputting polarized lights having the same wavelength. In this case, for example, PBC (Polarization Beam Combiner) couplers are employed for the couplers 215 and 216 shown in FIG. 4 to synthesize polarized waves.

When a pair of polarized lights are synthesized and supplied to the Raman amplification optical fiber 205 for backward pumping or forward pumping or the like, it becomes possible to effectively perform Raman amplification without any loss of pumping lights at the time of synthesis. Moreover, granted that either of the pumping light sources in one pair breaks down, halts outputting or reduces the output levels due to some failure, it becomes possible to minimize the distortion of a gain spectrum owing to the decreased light power level of the pumping light by controlling the other pumping light source having no failure to output a pumping light with an increased power level. This is realized because the pumping light from the other pumping light source has the same wavelength.

As above, there are many advantages to synthesize a pair of polarized lights. However, when there is a limit in the number of pumping light sources to be mounted in a repeater in view of power consumption and heat developed, only the half of the wavelengths of the pumping lights is to be available from one repeater. For this reason, it was difficult to synthesize a pair of polarized lights (polarized waves) in a repeater so as to achieve a flattened gain spectrum. However, according to the present invention, the pumping light sources in plural repeaters in a gain control zone are utilized in common as if the pumping light sources are employed in one repeater. Accordingly, it becomes possible to employ sufficient variety of pumping lights, which will not be any obstacle to obtain a flattened gain spectrum.

As set forth hereinbefore, according to a first aspect of the present invention, for achieving the objects mentioned above, there is provided an optical transmission system with optical amplifier repeaters, wherein a plurality of repeaters each of which outputs a pumping light with a different pumping wavelength spectrum to realize a different gain spectrum are located in a predetermined gain control zone in an optical fiber transmission line for Raman amplification Namely, a gain control zone is provided in the optical fiber transmission line for transmitting signal lights. Further, the respective repeaters in the gain control zone output pumping lights with different pumping wavelength spectra to obtain different gain spectra. Ram an amplification is performed by using the different wavelengths from the repeaters in the gain control zone. Since the number of wavelengths used for the Raman amplification becomes severalfold compared with a case where Raman amplification is performed using a single wavelength from one repeater, it becomes possible to obtain a flatter gain spectrum.

As described above, an optical fiber transmission line for signal-light transmission is provided with a gain control zone for gain control. In the gain control zone, respective repeaters output pumping lights having different pumping wavelength spectra to realize different gain spectra. Accordingly, the number of the wavelengths of pumping lights from one repeater becomes more than double. This contributes to obtaining a flattened gain spectrum and reducing power consumption and heat in the respective repeaters.

According to a second aspect of the present invention, in the first aspect, the whole of the optical fiber transmission line is divided into a plurality of gain control zones each having the approximately the same length.

Namely, the plural gain control zones each having almost the same length are repeatedly allocated to the whole of the optical fiber transmission line. Since the gain control zones are sequentially repeated, signal lights can be transmitted always in good condition. Incidentally, there is no need to configure all of the gain control zones with the same configuration (length). For example, as the position approaches the end of the transmission line, the gain control zone may be shortened and the number of the repeaters may be reduced.

As described above, the respective gain control zones are obtained by dividing the whole of the optical transmission line in approximate equal size. Accordingly, a signal light can be transmitted in good condition all the time. This contributes to optical communication system with high quality.

According to a third aspect of the present invention, in the first aspect, at least one gain control zone is provided in the optical fiber transmission line.

In this case, the whole of the optical fiber transmission line is not divided into the gain control zones different from the above case. For example, when the whole of the transmission line is not equally divided into the gain control zones and some zones are left, it is possible to locate a normal repeater(s) in the leftover zone.

Namely, at least one gain control zone is provided in the whole optical transmission line. Therefore, it becomes possible to increase the flexibility when constructing the optical transmission system.

According to a fourth aspect of the present invention, in the first aspect, the pumping wavelength spectrum from each repeater is determined so that a total gain spectrum obtained by Raman amplification using a total pumping wavelength spectrum made of the different pumping wavelength spectra within one gain control zone becomes flatter than a gain spectrum obtained by Raman amplification using a single pumping wavelength spectrum from each repeater.

This aspect relates to a selection of a pumping wavelength S spectrum of each repeater. Namely, the pumping lights are allotted in advance to the respective repeaters by design so as to flatten a total gain spectrum through the Raman amplification. Accordingly, it becomes possible to effectively flatten a total gain spectrum in the gain control zone.

Namely, the pumping wavelength spectrum from each repeater is determined so that a total gain spectrum obtained by Raman amplification using a total pumping wavelength spectrum made of the different pumping wavelength spectra from the respective repeaters within one gain control zone becomes flatter than a gain spectrum obtained by Raman amplification using a single pumping wavelength spectrum from each repeater. Therefore, it becomes possible to effectively flatten a gain spectrum with high accuracy.

According to a fifth aspect of the present invention, in the first aspect, the optical transmission system with optical amplifier repeaters further includes (1) an optical source failure monitoring section for detecting an occurrence of a failure in at least one of pumping light sources which constitute the respective repeaters in the gain control zone, and (2) a gain spectrum compensating section for, when the optical source failure monitoring section detects a failure, compensating a distortion caused by the failure in a gain spectrum.

This aspect relates to a countermeasure against an occurrence of a failure in one of the pumping light sources included in a repeater in the gain control zone. When the optical source failure monitoring section detects a failure, the gain spectrum compensating section compensates a distortion caused by the failure in a gain spectrum. Concretely, the gain spectrum compensating section uses a backup pumping light source that outputs the same or a proximate wavelength in place of the pumping light source having the failure.

Namely, a light source failure monitoring section monitors and compensates distortion of a gain spectrum. Consequently, it becomes possible to secure the stability of the system in addition to a flattened gain spectrum.

According to a sixth aspect of the present invention, in the first aspect, each of the repeaters includes (1) at least one pair of polarized wave pumping light sources which output pumping lights having the same wavelength, and (2) a polarized wave synthesizing section for synthesizing polarized waves of the pumping lights from the pair of the polarized wave pumping light sources.

Namely, at least one pair of polarized wave pumping light sources are used in a repeater, and the polarized wave synthesizing section synthesizes the polarized waves. By this means, it becomes possible not only to increase the optical power of the pumping lights but also Lo continue to output the pumping light having the same wavelength when a failure occurs in either of the pumping light sources in the pair.

As described above, each repeater is provided with at least one pair of polarized wave pumping light sources which output pumping lights having the same wavelength, respectively, and provided with a polarized wave synthesizing section for synthesizing polarized lights having polarized waves from the pair of the polarized wave pumping light sources. Therefore, the pumping lights can be effectively output. Further, even when either of the pumping light sources in one pair halts its output, the Raman amplification can be continued using the wavelength of the pumping light from the other pumping light source if the other pumping light source can be available.

According to a seventh aspect of the present invention, in the sixth aspect, the optical transmission system with optical amplifier repeaters further includes a gain spectrum compensating section for, when a failure occurs in an output of the pumping light from either of the polarized wave pumping light sources in the pair, compensating a distortion of a gain spectrum caused by the failure by controlling an output from the other polarized wave pumping source.

Namely, the gain spectrum compensating section increases the output from the other pumping light sources having no failure. Accordingly, it becomes possible to prevent or minimize the distortion (deterioration) of the gain spectrum.

As described above, by the use of a gain spectrum compensating section, it becomes possible to prevent and minimize the distortion of a gain spectrum by increasing the output level of a pumping light source having no failure in one pair.

According to an eighth aspect of the present invention, there is provided an optical transmission system with optical amplifier repeaters, comprising (1) a plurality of optical amplifier repeaters, which are located in an optical fiber transmission line at intervals, for supplying pumping lights output from a plurality of pumping light sources to a plurality of Raman amplification optical fibers, respectively, and (2) a gain control device including a gain characteristic determining section for inputting signal lights transmitted via the optical amplifier repeaters to determine gain characteristics in a frequency range necessary for transmitting all of the signal lights, and a power adjustment instructing section for, when the gain characteristic determining section determines that predetermined gain characteristics have not been obtained, instructing an optical amplifier repeater, which includes a pumping light source for outputting a pumping light required for achieving the gain characteristics, from among the plural optical amplifier repeaters to adjust the power of the optical amplifier repeater.

Namely, the optical fiber transmission line is provided with a plurality of optical amplifier repeaters and a gain control device for monitoring and controlling the repeaters. The gain control device inputs the signal lights transmitted via the optical amplifier repeaters into the gain characteristic determining section to determine gain characteristics in a frequency range in which the whole signal lights are transmitted. Subsequently, when the gain characteristic determining section determines that predetermined gain characteristic has not been achieved for some reason, the power adjustment instructing section instructs an optical amplifier having a pumping light source that outputs a pumping light necessary for achieving the predetermined gain characteristics. By this means, it becomes possible to totally compensate a gain spectrum when a failure occurs in, for example, at least one of the pumping light sources in the optical transmission system with optical amplifier repeaters.

As described above, a gain control device issues instructions only to a corresponding optical amplifier repeater(s) from among the plural optical amplifier repeaters to output a pumping light necessary for obtaining a target gain characteristic. Consequently, the gain control device does not have to be provided with a pumping light source(s), thereby realizing a simplified configuration of the gain control device.

According to a ninth aspect of the present invention, there is provided an optical transmission system with optical amplifier repeaters, comprising (1) a plurality of optical amplifier repeaters, which are located in an optical fiber transmission line at intervals, for supplying pumping lights output from a plurality of pumping light sources to a plurality of Raman amplification optical fibers, respectively, and (2) a gain control device including a gain characteristic determining section for inputting signal lights transmitted via the optical amplifier repeaters to determine gain characteristics in a frequency range necessary for transmitting all of the signal lights, a plurality of pumping light sources for outputting pumping light sources having different wavelengths, respectively, and a power adjustment instructing section for when the gain characteristic determining section determines that predetermined gain characteristics have not been obtained, instructing a power source for outputting a pumping light required for achieving the gain characteristics from among the plural pumping light sources to adjust the power of the pumping light source.

Namely, the optical fiber transmission line is provided with a plurality of optical amplifier repeaters and a gain control device for monitoring the repeaters and compensating a gain. The gain control device inputs signal lights transmitted via the optical amplifier repeaters into the gain characteristic determining section to determine gain characteristics in a frequency range in which all of the signal lights are transmitted. Subsequently, when the gain characteristic determining section determines that predetermined gain characteristics have not been achieved for some reason, the output adjusting section instructs a pumping light source for outputting a pumping light necessary for achieving the predetermined characteristics from among the plural pumping light sources to adjust the output from the pumping light source. Accordingly it becomes possible for the gain control device to compensate a gain spectrum by itself without controlling the respective optical amplifier repeaters. Further, it becomes possible to control a gain spectrum without employing a complicated circuitry in each optical amplifier repeater.

As described above, a gain control device is provided with a plurality of pumping light sources to perform gain compensation by itself In addition, the gain control device may be configured so as to issue instructions to a plurality of optical amplifier repeaters to output pumping lights. Accordingly, it becomes possible to perform gain spectrum control more accurately.

According to a tenth aspect of the present invention, in the eighth or ninth aspect, each of the optical amplifier repeaters includes an optical circulator for inputting in the optical amplifier repeater main signals transmitted via the optical fiber transmission line, and outputting the pumping lights from the plural pumping light sources to the optical fiber transmission line in the direction opposite to the direction where the main signals are transmitted.

Namely, each of the repeaters is provided with an optical circulator. Accordingly, it becomes possible to easily perform controls of inputting signal lights and supplying a pumping light for backward pumping to the Raman amplification optical fiber.

All described above, each repeater is provided with an optical circulator. Accordingly, it becomes possible to easily perform a control of inputting signal lights and supplying pumping lights for backward pumping to a Raman amplification optical fiber.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An optical transmission system with optical amplifier repeaters, comprising:
a plurality of repeaters each of which has a plurality of pumping light sources and outputs a pumping light with a different pumping wavelength spectrum to achieve a different gain spectrum; and
an optical fiber transmission line for Raman amplification; wherein:
the repeaters are located in a predetermined gain control zone allocated to the optical fiber transmission line.

2. An optical transmission system with optical amplifier repeaters as claimed in claim 1, wherein:
a plurality of gain control zones each having approximately the same length is allocated to the whole of the optical fiber transmission line.

3. An optical transmission system with optical amplifier repeaters as claimed in claim 1, wherein:
at least one gain control zone is allocated to the optical fiber transmission line.

4. An optical transmission system with optical amplifier repeaters as claimed in claim 1, wherein:
the pumping wavelength spectrum from each repeater is determined so that a total gain spectrum obtained by Raman amplification using a total pumping wavelength spectrum made of the different pumping wavelength spectra within one gain control zone becomes flatter than a gain spectrum obtained by Raman amplification using a single pumping wavelength spectrum from each repeater.

5. An optical transmission system with optical amplifier repeaters as claimed in claim 1, including:
an optical source failure monitoring section for detecting an occurrence of a failure in at least one of the pumping light sources; and
a gain spectrum compensating section for, when the optical source failure monitoring section detects a failure, compensating a distortion in a gain spectrum caused by the failure.

6. An optical transmission system with optical amplifier repeaters as claimed in claim 1, wherein:
each of the repeaters includes:
at least one pair of polarized wave pumping light sources which output pumping lights having the same wavelength; and
a polarized wave synthesizing section for synthesizing polarized waves of the pumping lights from the pair of the polarized wave pumping light sources.

7. An optical transmission system with optical amplifier repeaters as claimed in claim 6, including:
a gain spectrum compensating section for, when a failure occurs in an output of the pumping light from either of the polarized wave pumping light sources in the pair, compensating a distortion of a gain spectrum caused by the failure by controlling an output from the other polarized wave pumping source.

8. An optical transmission system with optical amplifier repeaters, comprising:
an optical fiber transmission line;
a plurality of Raman amplification optical fibers;
a plurality of optical amplifier repeaters; and
a gain control device; wherein:
the respective optical amplifier repeaters include a plurality of pumping light sources;
the respective optical amplifier repeaters are located in the optical fiber transmission line at intervals, and supply pumping lights from the plural pumping light sources to the corresponding Raman amplification optical fibers; and
the gain control device includes:
a gain characteristic determining section for inputting therein signal lights transmitted via the optical amplifier repeaters to determine gain characteristics in a frequency range required for transmitting all of the signal lights; and
a power adjustment instructing section for, when the gain characteristic determining section determines that predetermined gain characteristics have not been obtained, instructing an optical amplifier repeater, which includes a pumping light source for outputting a pumping light required for achieving the gain characteristics, from among the plural optical amplifier repeaters to adjust the power of the optical amplifier repeater.

9. An optical transmission system with optical amplifier repeaters as claimed in claim 8, wherein:
the gain control device further includes a plurality of pumping light sources each of which outputs a pumping light having a different wavelength, wherein:
when the gain characteristic determining section determines that predetermined gain characteristics have not been obtained, the power adjustment instructing section instructs a power source for outputting a pumping light required for achieving the gain characteristics from among the plural pumping light sources to adjust the power of the pumping light source.

10. An optical transmission system with optical amplifier repeaters as claimed in claim 8, wherein:
each of the optical amplifier repeaters includes an optical circulator for inputting in the optical amplifier main signals transmitted via the optical fiber transmission line, and outputting the pumping lights from the plural pumping light sources to the optical fiber transmission line in the direction opposite to the direction where the main signals proceed.

11. An optical transmission system with optical amplifier repeaters as claimed in claim 9, wherein:
each of the optical amplifier repeaters includes an optical circulator for inputting in the optical amplifier main signals transmitted via the optical fiber transmission line, and outputting the pumping lights from the plural pumping light sources to the optical fiber transmission line in the direction opposite to the direction where the main signals proceed.
